(19) United States
(12) Patent Application Publication
(10) Pub. No.: US 2003/0088511 A1
(43) Pub. Date: May 8, 2003

(54) Method and system for access and usage management of a server/client application by a wireless communications appliance

(76) Inventors: Peter Panagiotis Karboulonis, Manchester (GB); George Karboulonis, Manchester (GB); Gordon Dixon, Manchester (GB); Jason Peter Cooper, Doncaster (GB)

Correspondence Address: PATRICK REILLY, BOX 7218, SANTA CRUZ, CA, 95061-7218, US

(21) Appl. No.: 10/175,629

(22) Filed: Jun. 20, 2002

Related U.S. Application Data
(60) Provisional application No. 60/303,640, filed on Jul. 5, 2001.

(51) Int. Cl. G06F 17/60

(52) U.S. Cl. 705/39

(57) ABSTRACT

A method and system for accessing and usage management of a software application residing on a remote server and communicating with a wireless electronic communications device is provided. The preferred embodiment allows the user to receive the benefits of access to the software application and without requiring consent or approval of telecommunications carriers, operators or agents. The software application may be a game, an animation generator, a database management system, an agent, an avatar or another useful software structure known in the art. The preferred embodiment includes an account identification data set that may be partially or wholly resident or related to a physical card. The data set may define or help define a user profile, where the user profile identifies a user or consumer, and enables access to specified services, usage allotments, and access level authorizations to various optional, additional or premium functions and capabilities of the server application.

### FIELD OF THE INVENTION

The present invention relates to wireless access to server-resident software applications. The present invention further relates to methods and systems that empower wireless communication device users to access and interact with remotely located server software applications.

### BACKGROUND OF THE INVENTION

The telecommunications industry is rapidly expanding the capabilities and availabilities of information technology systems to the users of wireless communications devices. The population of wireless communications devices, such as cellular telephones, personal digital assistants, PALM handheld wireless electronic appliances, digital pagers, bidirectional digital pagers and other wireless information appliances known in the art, presents an attractive market for telecommunications operators, agents and carriers to sell usage of and access to services generated by network resident software applications. The conventional art of telecommunications service business model development and implementation is centered on schemes that position telecommunications infrastructure firms as indispensible providers of access information technology services and systems. These business methods and their supporting information technology systems and systems architectures are meant to limit the availability of third party information technology services and systems to user and consumers, and to require the user or consumer to pay access fees and usage fees directly to the telecommunications companies, their affiliates or agents.

There is, therefore, a long felt need for an information technology system and business model that enables a consumer to receive the benefits of direct access to third party information technology service providers and that reduces or eliminates a requirement to pay a telecommunications infrastructure company, carrier, affiliate or agent additional fees for the interactivity achieved by the consumer with the third party provider.

### SUMMARY OF THE INVENTION

It is an object of the present invention to provide an information technology system that enables a consumer to access and use a server or computer network based software application from a wireless electronic communications device. Towards the fulfillment of this and other objects, the method of the present invention includes a user account data set, computer network software that bi-directionally communicates with and delivers content to the wireless electronic communications device, and a software application. The computer network software may essentially provide access to and usage of the software application by the wireless device. The wireless electronic communications device, or wireless device, may in certain alternate preferred embodiments of the present invention, be a cellular telephone, a personal digital assistants, a PALM handheld wireless electronic appliance, a digital pager, bi-directional digital pager or another suitable wireless communications information appliance known in the art.

Certain still alternate preferred embodiments of the method of the present invention include an animation system or method for generating animation files that may be presented to a user via the wireless device.

Certain yet alternate preferred embodiments of the method of the present invention may alternately or additionally include or provide a server based or network based knowledge management system, whereby the user may interact with a information technology knowledge tool that employs a model of three dimensional space and enables the user to isolate and identify relationships of data within or among one or more data bases.

Certain preferred embodiments of the present invention include or are associated with a wireless gaming system. These preferred embodiments may optionally include an m-Card, an animation software utility, a server software package, and/or a three-dimensional navigation interface to a proprietary knowledge management system. The m-Card is or comprises a prepaid services card that may contain or be related to some or all of the user account data set.

The foregoing and other objects, features and advantages will be apparent from the following description of the preferred embodiment of the invention as illustrated in the accompanying drawings.

### BRIEF DESCRIPTION OF THE DRAWINGS

FIG. 1 is a schematic of an invented system, the invented system being a preferred embodiment of the present invention.

FIG. 2 is an illustration of an mCard of the invented system of FIG. 1.

FIG. 3 is a depiction of a FireCode User Registration Identification ID of the invented system of FIG. 1.

FIG. 4 is a depiction of a scrambled FireCode User Registration Identification (ID) of the invented system of FIG. 1.

FIG. 5 is a schematic of software modules of the invented system of FIG. 1.

FIG. 6 presents wireless devices in communication with a WAP Gateway and a Web Server and as a component of the invented system of FIG. 1.

FIG. 7 illustrates wireless devices in communication with a WAP Gateway and as a component of the invented system of FIG. 1.

FIG. 8 is an optional invented graphical interface that may be integrated into the invented system of FIG. 1.

FIG. 9 shows the mCard of FIG. 2 used in conjunction with wireless devices in communication with a WAP Gateway and a Web Server, and all as components of the invented system of FIG. 1.

FIG. 10 is a table of software classes used within the method of operation of the invented system of FIG. 1.

FIG. 11 is a schematic diagram of the operating system of the invented system of FIG. 1.

FIG. 12 is a schematic diagram of the software implemented within the invented system of FIG. 1.

FIG. 13 is a schematic diagram of query and data collection software operations implemented within the invented system of FIG. 1.

FIG. 14 is a plot of occurrences versus words/tokens observed in the operation of the invented system of FIG. 1.

FIG. 15 is a visualisation of a simplified three-dimensional view that may optionally by incorporated into the invented system of FIG. 1.

FIG. 16 is a schematic network employing the invented system of FIG. 1.

FIG. 17 is an HTTP/SSL request of the network of FIG. 16, written in pseudo-code.

FIG. 18 is an HTTP/SSL reply of the network of FIG. 16, written in pseudo-code.

FIG. 19 is a schematic of an alternate invented system designed according to the method of the present invention.

FIG. 20 is an illustration of an operating state of the alternate invented system of FIG. 19.

FIG. 21 is a schematic representation of elements of the alternate invented system of FIG. 19

FIG. 22 is a schematic illustration of a gatekeeper module located within the alternate invented system of FIG. 19.

FIG. 23 is a flow-chart of the process of the invented system of FIG. 19 designed in accordance with the method of the present invention continued in FIG. 24

### DETAILED DESCRIPTION OF A PREFERRED EMBODIMENT

In describing the preferred embodiments, certain terminology will be utilised for the sake of clarity. Such terminology is intended to encompass the recited embodiment, as well as all technical equivalents, which operate in a similar manner for a similar purpose to achieve a similar result.

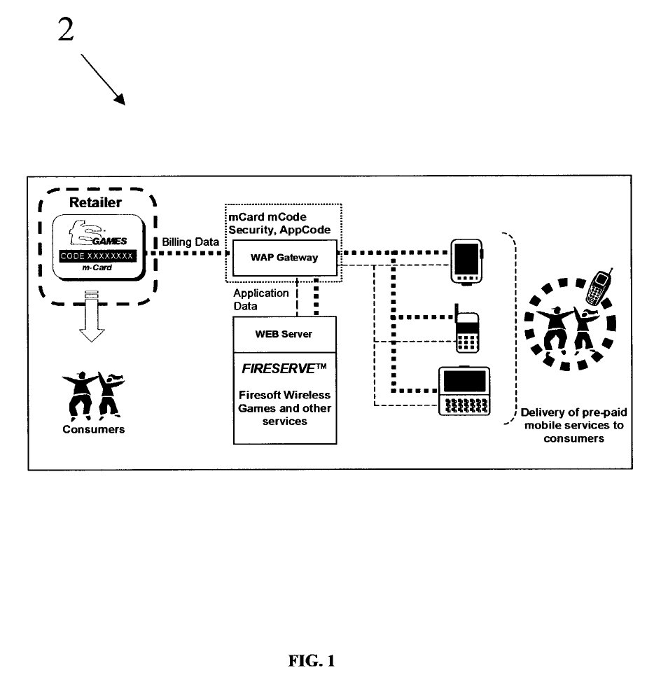

Referring now generally to the Figures and particularly to FIG. 1, a preferred embodiment 2, or invented system 2, bypasses traditional billing mechanisms as designed and adopted by telecommunications companies and their affiliates or agents. The method of the present invention enables a third party information technology services provider to bill consumers directly (nationally and internationally) for the provision of a service or and adopted by telecommunications companies and their affiliates or agents. The method of the present invention enables a third party information technology services provider to bill consumers directly (nationally and internationally) for the provision of a service or services over wireless networks including and not limited to GSM, GPRS, 3G and 4G for the provision of WAP related and other wireless services.

The method of the present invention thereby enables third party information technology providers and service vendors to lawfully provide and charge for their services without the consent of telecommunications operators, carriers or the affiliates or agents of telecommunications operators or carriers, thus encouraging and enabling the formation of an open market that discourages monopoly practices and encourages price and capability competition by information technology firms marketing to consumers, businesses, organisations, educational institutions, societies, public entities and private ventures.

The preferred embodiment of the present invention optionally comprises:

| | | |
|---|---|---|
| > | an m-Card: | possessed or accessible by an end user or consumer; |
| > | Fireserve: | software server enabling tools and/or technologies; and |
| > | WAP games: | and other suitable wireless software applications. |

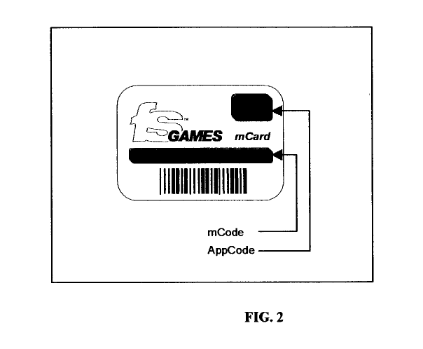

Referring now generally to the Figures and particularly to FIGS. 1 and 2, the m-Card may consist of or comprise a credit-card sized card that is distributed through retailers and other outlets to consumers and end users of the invented system 2. An m-Card may be marketed individually or as part of a pack or a kit. Each m-Card can have one or more unique codes on it that are related or contain, partially or entirely, the user account data set. These unique codes may be concealed when the card is purchased. The preferred embodiment has the unique codes of FireCode and AppCode.

FireCode and AppCode may consist of or comprise a number of alphanumeric characters, symbols and or graphic representations. These characters and symbols can be communicated to and/or from a computer system, or a computer network, by a keyboard, pen, touch-screen or other input device and/or through, but not limited to, other suitable methods known in the art and including speech, sound, music, menus, options lists, icons and other information bearing representations.

FireCode (FC) codes are encoded to provide security and billing data. Such data can be input through an Internet enabled device including mobile phones, communicators, Personal Digital Assistants, computers and consoles as well as over the phone, FAX, post etc. A registration code of the FireCode allows consumers to register with a mobile-based service or for ‘topping-up’ their current accounts.

FireCode may provide information as follows:

FC application ID;

FC user registration ID;

m-Card issue date;

m-Card retailer code; and

m-Card billing signature.

To summarize, the data related to or included within the FireCode is used to provide user billing, user/card/retailer tracking and security.

AppCode serves a different purpose then FireCode. The AppCode may by concealed from the user's sight by a nontransparent film. When the user removes the film, the m-Card may reveal a code that may or may not ‘win’ the consumer a prize. A prize may provide or include service access or usage benefits, such as a month of free gameplay, access to a hidden game level, additional game functionality in terms of special weapons, extra lives, etc.

AppCode (AC) is application specific and may provide additional information as follows:

AC m-Card bridge;

AC application ID;

AC application data;

AC access keys; and

AC services offers.

FC application ID, FC user registration ID and FC/AC bridge are unique on each m-Card. All other data may be application specific.

A number of software tools may be used to enable the invented system 2, to perform its functions. These may consist of or comprise software component server technologies identified as FireServe.

Certain software and other elements are useful for the invented system 2 to optimally function, such as:

Consumers with access to WAP enabled devices:

mobile phones;

mobile palm-tops;

mobile organizers; and

mobile communicators.

A Firesoft m-Card as supplied to retailers, m-Card supports:

user registration;

unique m-Card identification; and

encoded security (FireCode).

FireServe server software enabling technologies that consist of or comprise:

Application delivery technology that supports:

interactive WAP animated content without the need for scripting,

real-time multi-user support;

WAPSpy: A real-time data gathering system capable of logging data including:

device type

by manufacturer,

by model,

by browser release,

consumer ID

by name,

by alias/pseudonym,

mobile number;

consumer account details,

consumer profile:

dynamic profile builder,

manual user profile editor; and

FireBilling: A real-time billing system capable of providing invoicing information:

per device type,

per type of service,

per data packet sent,

the amount of data sent to the closest byte,

for the number of time connected to the system,

for the number of pages viewed,

for a set amount of time logged on a service.

There are two aspects of the system beyond the enabling FireServe technologies that make the invented system 2 function in a more effective manner, namely, FireCode and FirePre-emptive. FireCode is an m-Card encoded security code, and FirePre-emptive is a newly invented technique to provide real-time interactivity on WAP devices without the need of on-the-device scripting code (e.g., WMLScript).

The invented system 2 includes a novel procedure has been devised to generate unique encrypted FireCode character sequences. The FireCode character sequences may serve two purposes. Firstly, they may be used to carry useful data. Secondly, FireServe may validate the codes and reject pirated m-Cards and rogue FireCodes, thereby reducing or eradicating piracy of a retail software product. Character sequences for the various data codes may include the following aspects or elements as follows:

The Product Licensing Period Code

The product licensing code is 2 characters long, i.e. A1, A2. Only characters 0-9 are allowed. It is used to show the number of months that the user has paid, for example, one month, three months, etc.

The number of months may be encrypted in the A1, A2 code as follows:

A1, A2=(number of months paid for)*8+RND(1-7);

When decoded by the ASP:

Number of months to register user=int(val(A1,A2)/8);

For example:

Assume A1=5; A2=2;

[symbol]

val(A1,A2)=52;

[symbol]

Number of months to register user=int(52/8)=6;

The Issue Date Code

The issue date is 4 characters long, i.e. M1, M2, Y1, Y2. Characters 0-9 are allowed.

The Billing Signature Code (BSC)

The billing signature is used to identify and validate an old or new user. The Billing signature may consist of or comprise a plurality of characters, i.e. S1, S2, S3, S4, S5, S6, S7, S8, S9, S10. It is split in two parts. S1-S4 that is used to validate the m-Card and S5-S10 that is used to store the user number. Note the user number S5-S10 may have to be stored before S1, S2, S3, S4 can be calculated and filled. This is calculated progressively, every time BSC gets a new value assigned to it fields S1, S2, S3, S4 are immediately updated, i.e.

BSC=0;

BSC=S5+S6+S7+S8+S9+S10;

Store the characters that form BSC in S1, S2, S3, S4 and use them in all further calculations

BSC=BSC+(S1*A1)+(S2*A2)+(S3*M1)+(S4*M2);

Store the characters that form BSC in S1, S2, S3, S4 and use them in all further calculations

BSC=BSC*(A1+M2+Y2)+(A2+M1+Y1);

Store the characters that form BSC in S1, S2, S3, S4 and use them in all further calculations

BSC=BSC+(S1*S7)+(S2*S8)+(S3*S9)+(S4*S10); and

The final value of BSC is then stored in S1, S2, S3, and S4.

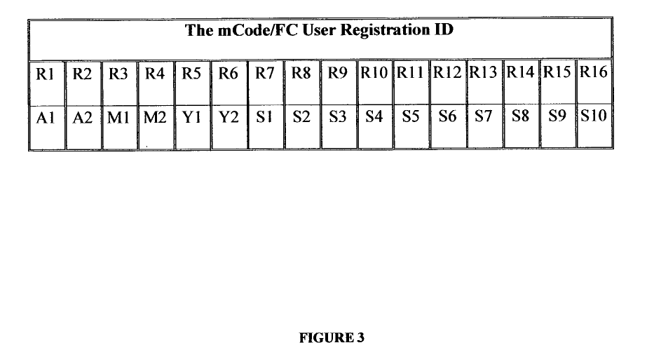

Referring now generally to the Figures and particularly to FIG. 3, a FireCode/FC User Registration ID (identification) is presented.

The FireCode/FC user Registration ID

The FireCode (FC user Registration ID) printed on m-Card is constructed from the application ID, issue date, billing signature and user number, subsequently it is 16 characters long, i.e. R1, R2, . . . , R16.

FireCode Generation

For the invented system 2 to generate a FireCode code 16 one character empty fields must be filled as follows:

| | | |
|---|---|---|
| 1. Product licensing period-months | A1-A2, | range: 01-99; |
| 2. The Issue Month Code | M1-M2, | range: 01-12; |
| 3. The Issue Year Code | Y1-Y2, | range: 01-99; |
| 4. The Billing Signature Code 1/2 | S1-S4, | range: 0000-9999; and |
| 5. The Billing Signature Code 2/2 | S4-S10, | range: 000000-999999. |

To create the Product Licensing Period code and the Billing Signature Code (BSC) please refer to the previous commentary.

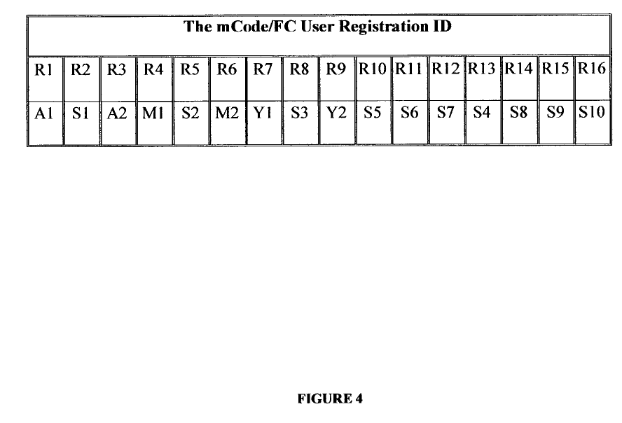

Referring now generally to the Figures and particularly to FIG. 4, the FireCode/FC User Registration ID can be further scrambled to make unauthorised decoding of the code more improbable using suitable techniques known in the art.

Checking the Code

When a user submits a code the code will have to be checked for being valid. To do this use the arithmetic values of the 16 characters submitted by the user to reconstruct the contents of S1, S2, S3, and S4 from scratch as follows:

S1=0; S2=0; S3=0; S4=0;

BSC=0;

BSC=S5+S6+S7+S8+S9+S10;

Store the characters that form BSC in S1, S2, S3, S4 and use them in all further calculations

BSC=BSC+(S1*A1)+(S2*A2)+(S3*M1)+(S4*M2);

Store the characters that form BSC in S1, S2, S3, S4 and use them in all further calculations

BSC=BSC*(A1+M2+Y2)+(A2+M1+Y1);

Store the characters that form BSC in S1, S2, S3, S4 and use them in all further calculations

BSC=BSC+(S1*S7)+(S2*S8)+(S3*S9)+(S4*S10).

The new (ASP) calculated BSC value should be a four-digit number and its characters should be identical and in sequence to the S1, S2, S3 and S4 characters that form part of FireCode as found on the m-Card submitted to the system (ASP) by the user.

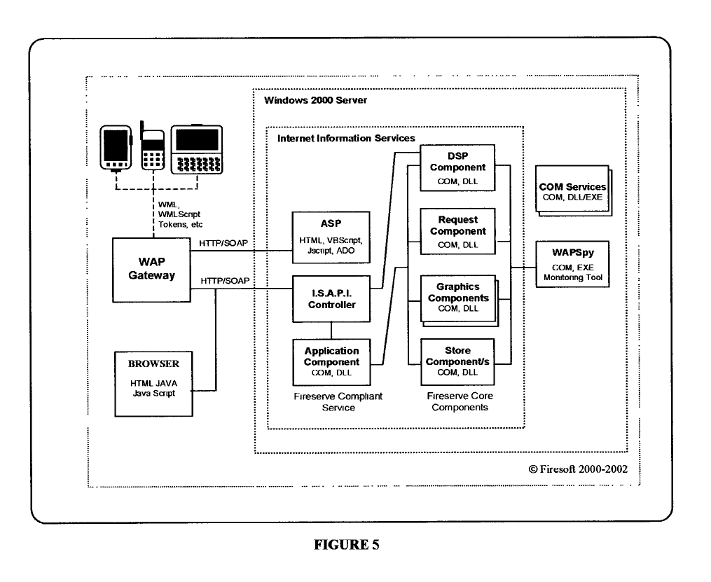

Referring now generally to the Figures and particularly to FIG. 5, the method of the present invention, and the preferred embodiment, further comprise a FirePre-emptive Animation software that provides for interactivity when playing animated games on a mobile phone and without the need of either a scripting language (i.e. WML Script, JavaScript) or for logical processing on the wireless device.

Instead, in the invented system 2, all logic flow of the game application may take place on a remote server. The method of the present invention as implemented in the preferred embodiment thereby largely bypasses the expected latencies and continuous interruptions found in the prior art by pre-processing a variable number of upcoming game turns and feeding these speculative or predicted outcomes to the wireless device in advance and in one single process. This optional element of the method of the present invention achieves uninterrupted animation that can be interrupted by the user at any point. This optional feature of the method of the present invention enables changes in the flow of the game depending on the user input, or by the server when a pre-established list of game turns runs out.

The invented FireServe technology allows us to achieve this in an efficient manner while serving a large number of players using mobile WAP enabled phones.

The preferred embodiment further comprises FireServe™. FireServe™ is a highly optimised, multi-threaded C++ based software server solution that supports load balancing. FireServe™ is geared to deliver content to wireless devices and can support real-time single and multi-user environments.

FireServe allows for complex and demanding applications such as games and multimedia content. High efficiency in the server is essential due to a combination of small inefficient caches, and the inability of most WAP mobile devices to handle WML and WML Script satisfactorily. FireServe™ goes well beyond existing JAVA based software solutions and similar alternatives.

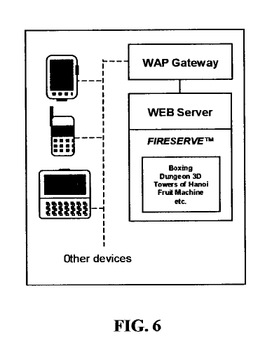

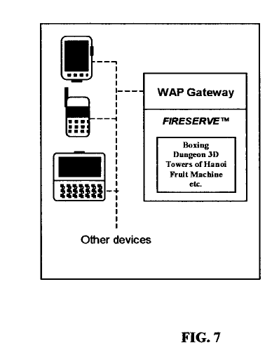

Referring now generally to the Figures and particularly to FIGS. 6 and 7, FireServe™ has been designed and developed to take advantage of GSM, GPRS and 3G technologies and incorporates an innovation that allows for the support of multiplayer, persistent and non-persistent environments (including games) without the use of PUSH WAP technologies that normally enable two way communication. Instead FireServe™ uses the timer units found on these devices to enable two-way communication between wireless devices and an arrangement of servers or other wireless devices. The timer on a device is used to automatically issue a request or requests to a server at intervals to enable for the efficient exchange of data and for synchronising the events within a multi-user environment so that all participants share the same experience.

Referring now generally to the Figures and particularly to FIGS. 5, 6 and 7, Firesoft's FireServe™ server allows complex games and other applications to be processed on a Windows 2000 server arrangement rather than on the mobile device. This arrangement allows most WAP mobile phones that are capable of displaying graphics to run games far more complex than are currently available. FireServe™ currently supports all WAP phones that include devices from Motorola, Ericsson, Nokia, Sony, Mitsubishi, Siemens, etc. Real-time animation is supported on only some of these phones to varying degrees.

Server Deployment

Once installed on a server FireServe™ can optionally be in control of all Firesoft games' applications running on the server and will process user requests accordingly.

Referring now generally to the Figures and particularly to FIGS. 6 and 7, FireServe™ has been developed in C++ using MS COM/DCOM (Active X) technologies and runs under Windows 2000 Server or later. The run-time server architecture is highly modular and allows for remote monitoring and control over an Internet browser or mobile phone.

In certain suitable situations, and in an effort to maximise resources, FireServe™ could reside on the WAP Gateway server. This residence would further enhance performance and reduce costs. For this to be able to happen the cooperation of the telecommunication operator is necessary.

FireServe™ is not just a WAP server, it can optionally be used to distribute content over a variety of carrier technologies and may optionally outperform similar JAVA solutions. For graphics based applications the FireServe™ performance advantage is likely to increase further where in some cases JAVA solutions would fail to deliver altogether.

In addition FireServe™ is capable of real-time performance unlike JAVA based server solutions that can be described as poor performers. FireServe™ produces desirable performance by having direct access to the operating system including software and hardware multimedia and graphics subsystems. FireServe™ has been designed to deliver text, graphics, sound, animations, video etc. FireServe™ is a highly optimised multi-threaded server application taking full advantage of multi-processor systems and has been designed with load balancing in mind. The FireServe™ architecture guarantees efficient, real-time delivery of content over GSM, GPRS and 3G. Content can include text, graphics, animations, sound and video where supported by mobile devices.

Performance

A plurality of WAP users may be concurrently served when playing applications on a single processor Intel 733 MHz Pentium 3 personal PC.

Specific FireServe™ Technical information of optional aspects are as follows:

FireServe™ optionally may be or comprise a collection of binary components implemented using the COM (component object model) specification running on the Windows 2000 operating system. Certain possible advantages of COM as optionally found in FireServe™ include:

Object-orientated design—COM objects support encapsulation, inheritance and polymorphism, the three cornerstones of object-oriented design.

Programming language independence—COM objects can be programmed in any language that can support the binary layout that COM specifies.

Reusability—Because COM objects are encapsulated and their implementation is isolated from the interface, they are reusable.

Interoperability—COM objects promote interoperability among applications and objects. More than one application or component can share the same COM object.

Location transparency—COM objects are location independent. They can be placed on the same computer or on different computers.

Independent, uncoordinated evolution—Because COM is extensible, COM objects can evolve without breaking their predecessors.

Deployment—COM objects are self-contained, reusable components, making them relatively easy to deploy and use.

Efficiency—COM objects are efficient in that they can be small, light, fast, and easy to deploy, can evolve and can be deployed anywhere.

The FireServe™ components have the following optional characteristics:

Coded in highly optimised C++ and assembly for top performance.

Small footprint so that they can be deployed even on moderate servers.

Multi-threaded components incorporating thread pooling for maximum design flexibility.

Bi-directional component communication.

Seamless integration with IIS (Internet Information Services).

Full access to the services of the operating system i.e. Direct X, MS Media Services.

Expandable across the LAN for distributed processing.

Ideal for rapid application (service) and content development due to the DSP (dynamic server pages) sub-system.

Enables performance monitoring, locally or remotely via the W@PSPY™ component.

The run-time server architecture is highly modular and allows for remote monitoring and control. There are currently no plans for a UNIX version of the server but this may change in the near future.

FireSearch

The preferred embodiment further comprises FireSearch™. FireSearch™ demonstrates the invented system's 2 optional and newly invented knowledge management system and interface, and the optional and newly invented real-time 3D navigation tool. FireSearch may be used in viewing, editing and navigating through knowledge and information as created by Fireserve through the m-Card concept, as well as through other data sets or structures that include but are not limited to text files, spreadsheets, Internet traffic, streamed data and suitable data structures and formats known in the art and received from other information sources and media.

FireSearch™ is an inventive method that provides, in certain alternate preferred embodiments of the present invention, information and knowledge management applications that are accessible via prior art and future generation wireless and landline networks.

FireSearch™ is a user knowledge management software concept that can alternately function on a number of single or networked computers and other suitable devices known in the art that may include, but are not limited to, workstations, servers, laptop and portable computers, interactive TV boxes, and mobile and wireless devices including and not limited to telephones and Personal Digital Assistants (PDA's).

Such wireless or wired devices may function independently or as part of a network that includes, and is not limited to, landline, optical, infra-red and sonic networks and other suitable networks for, and methods of, data transmission known in the art.

FireSearch™ builds an image of the information and knowledge stored on a single, or two, or a plurality of networked devices or computers. This image may be stored on a central server arrangement or, on a single device, and becomes available to a number of users to explore through the invented user interface. The invented interface allows users to access information instantly and intelligently following a request. The invented FireSearch system 2 has the ability to automatically update the image as new information and additionally or alternatively add files. The invented system 2 is able to assist and guide the user in navigating through the displayed information and a knowledge-containing data structure.

Subsequently knowledge stored on a central server arrangement, or other suitable arrangement known in the art, connected to the Internet may become automatically available to users via networked devices worldwide, e.g. workstations, interactive TV boxes, mobile phones, laptops, personal digital assistants.

The FireSearch interface may be be divided into two aspects, i.e. the Human Machine Interface, or HMI, and FireSoft's 3D Knowledge Navigation Interface.

HMI

Input may be achieved by, but not limited to, two-dimentional devices such as keyboards, light-pens, mice, track balls, joysticks, tablets, and three dimentional input devices such as tracked gloves and wands, and other suitable uni-dimensional or multi-dimensional data input systems or tools known in the art.

Output may be achieved by, but is not limited to, two dimentional output devices such as Liquid Crystal Displays (LCD) and TFT displays, cathode Ray Tubes (CRT), projectors and three dimentional output devices using optical, shutter glass, polarisation, and laser technologies, and other suitable uni-dimensional or multi-dimensional data output systems or tools known in the art.

The invented system 2 optionally employs algorithms that react to a user's request for information. The invented system 2 may automatically search through structured and unstructured information or data within a defined domain and isolate members or elements of information relevant to the user's query.

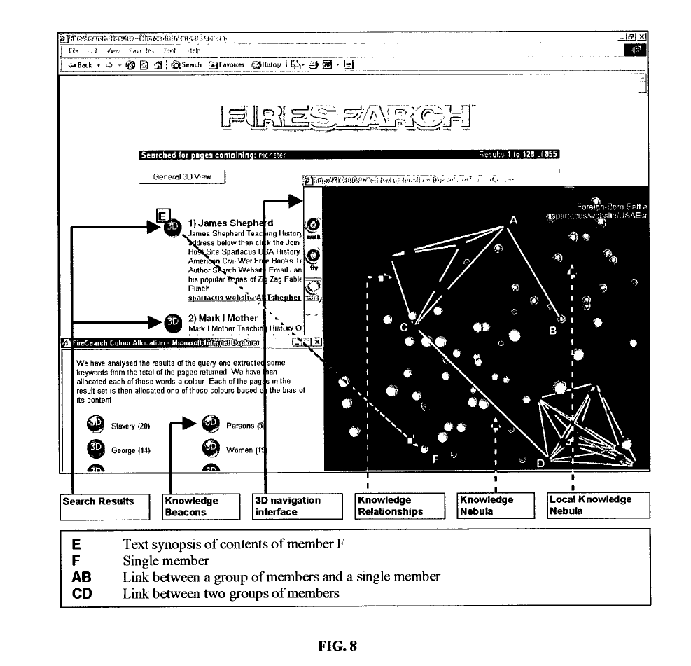

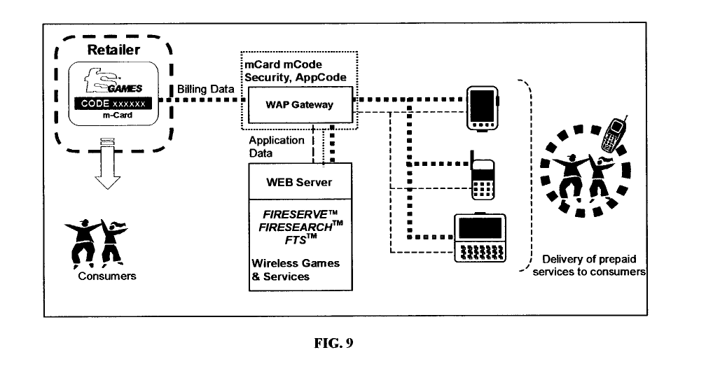

Referring now generally to the Figures and particularly to FIGS. 8 and 9, the selected members and/or elements are subsequently analyzed by the invented system 2 and grouped with regard to context. Furthermore, the system 2 dynamically creates diverse relationships between the selected members and/or elements as well as between groups of members and/or elements.

Referring now generally to the Figures and particularly to FIG. 8, the employment of an innovative graphical navigation mechanism enables users to individually or collaboratively navigate through selected groups, elements and members to view information of their choice.

A real-time and dynamic, three-dimensional interface is used to present the members. Information, knowledge and data are represented in 3D space as 2D and 3D shapes of different color, structure and texture. Members of similar context are depicted in comparable fashion and are spatially related.

Relationships between groups and/or single elements or members are depicted through links represented in space as 2D and 3D shapes of different color, structure and texture. Links may be presented and are not limited to lines of different thickness, color and texture that signify the type of link. Links and members may have additional information attached to them in terms of supplementary shapes including text or they can be constructed out of text and other shapes.

Links and members are dynamic in the way they are presented through a session, as some or all of their attributes may dynamically or otherwise change to convey a different set of messages to the user.

The invented system 2 allows for the dynamic manipulation of some or any of the elements and/or members that form the total knowledge structure. The invented system 2 facilitates navigation by suggesting worthwhile search paths to the user through a variety of methods including, but not limited to, highlighting useful paths and members, hiding insignificant links, members or groups of members and marking members visited by the user or newly introduced in the 3D model.

Referring now generally to the Figures and particularly to FIG. 9, the invented system 2 optionally enables third party information technology providers and service vendors to lawfully provide and charge for their services without the consent of telecommunications operators, carriers or the affiliates or agents of telecommunications operators or carriers, thus encouraging and enabling the formation of an open market that discourages monopoly practices and encourages price and capability competition by information technology firms marketing to consumers, businesses, organisations, educational institutions, societies, public entities and private ventures.

The invented system 2 optionally bypasses traditional billing mechanisms as designed and adopted by telecommunications companies and their affiliates or agents. The technology enables its bearer to bill consumers directly (nationally and internationally) for the provision of a service or services over wireless networks including and not limited to GSM, GPRS, 3G and 4G for the provision of WAP and other wireless services.

The invented system 2 may optionally comprise each of the following:

| | |
|---|---|
| m-Card | A prepaid services card available to consumers through |
| | retailers with one or more concealed codes; |
| FireServe | Software server enabling technologies used in the |
| | delivery of content over wireless networks; |
| Fire Pre-emptive | An innovative method that provides for interactivity |
| Animation: | when playing animated interactive games on a mobile |
| | phone without the need of a scripting language; |
| FireSearch: | a knowledge management/information system used in |
| | visualising and analysing consumer data and other |
| | information collected via m-Card, via FireServe and |
| | through other means; and |
| WAP games: | as designed and developed and delivered to consumers |
| | via the invented system 2. |

A number of software tools may be deployed to enable the invented system 2 to perform its functions. These enabling software tools may consist of or comprise software component server technologies identified as FireServe; an information/knowledge management system called FireSearch and Fire Pre-emptive animation, a technique that allows interactive animation on phones without the need of the on-board scripting (logical flow) facilities.

A number of elements may be required for the invented system 2 to physically function, they are as follows:

Consumers with access to WAP enabled and other wired and wireless devices

mobile phones

mobile palm-tops

mobile organizers

mobile communicators

other mobile and non mobile devices including PCs;

An m-Card (mobile-Card) as supplied to retailers, m-Card supports:

user registration

unique m-Card identification

encoded security (FireCode)

billing information

other data;

FireServe server software enabling technologies that consist of or comprise:

Application delivery technology that supports:

interactive WAP animated content without the need for scripting

real-time multi-user support

WAPSpy: A real-time data gathering system capable of logging data including:

device type

by manufacturer

by model

by browser release

other data

consumer ID

by name

by alias/pseudonym

mobile number

other

consumer account details

consumer profile

dynamic profile builder

manual user profile editor

FireBilling: A real-time billing system capable of providing invoicing information:

per device type

per type of service

per data packet sent

the amount of data sent to the closest byte

for the number of time connected to the system

for the number of pages viewed

for a set amount of time logged on a service

FireSearch, a newly invented information/knowledge management technology, that consists of or comprises:

a set of algorithms capable of categorizing structured and unstructured data in terms of content, context and other relationships useful in identifying otherwise ‘hidden’ facts

a unique real-time 3D interface for navigating through information, knowledge and data revealing hidden relationships and associations.

FirePre-emptive animation that provides real-time interactivity on WAP devices without the need of on-the-device scripting (e.g., WMLScript) that is the norm.

Referring now generally to the Figures and particularly to FIGS. 2, 3 and 9, the m-Card may comprise a credit-card sized card that is distributed through retailers and other outlets. Each m-Card can have one or more unique codes on it that may or may not be related. These are concealed when the card is purchased individually or as part of a pack. Code types include and are not limited to FireCode and AppCode as detailed below.

Codes like FireCode and AppCode consist of or comprise a number of alphanumeric characters, symbols and/or graphic representations. These characters and symbols can be inserted using a keyboard, pen, touch-screen or other input device and/or through but not limited to other methods including speech, sound, music, menus, options lists, icons and other representations.

FireCode (FC) codes are encoded to provide security and billing data. Such data can be input through an Internet enabled device including mobile phones, communicators, personal digital assistants, computers and consoles as well as over the phone, FAX, post etc. The registration of the on card FireCode allows consumers to register with a mobile-based service or for ‘topping-up’ their current accounts.

FireCode is used to provide information and may include but is not limited to:

FC product licensing period;

a m-Card issue date;

FC Validation Code (Billing Signature Code 2/2);

FC user registration ID (Billing Signature Code 2/2); and

billing/top-up information.

A procedure that generates unique encrypted FireCode character sequences that serves two purposes. First, the character sequences are used to carry useful data. Second FireServe can validate the codes and reject pirated or already registered m-Cards and rogue FireCodes, thus possibly reducing or eradicating piracy for the first time for a retail software product. When a user submits a code the code is checked for validity before allowing registration or a topping up of an existing account.

AppCode (AC) may serve a different purpose. The AppCode is hidden behind a nontransparent film placed over the card stock. When scratched away, the user can observe the code, which may or may not ‘win’ the consumer a prize. A prize may be in terms of a month of free gameplay, access to a hidden game level, additional game functionality in terms of special weapons, extra lives, other prizes, including monetary gains, etc.

AppCode is application specific and may provide the following additional, and other, information:

AC m-Card bridge (for validation purposes);

AC application ID;

AC application data;

AC access keys; and

AC services offers.

FC application ID, FC user registration ID and FC/AC bridge may be unique on each m-Card. All other data may be application specific. AppCode's structure, content and use may vary depending on the service provided. Additional codes may also be created to replace or to add to current codes and coding schemes.

FireServe is a newly invented server system that may include software programs, libraries and components running on a computer server. Various necessary and optional entities of FireServe are outlined below.

The FireServe Core Components (FCC) is or comprises a collection of binary software components running on a world-wide-web server. It provides functionality for web-based and WAP based applications that need to provide content (services) to various types of user agents (browsers) over the HTTP (hypertext transfer protocol) and SOAP (simple object application protocol) protocols. Such content includes HTML (hypertext modelling language), WML (wireless modelling language), WMLScript (wireless modelling language script), HDML (handheld device modelling language), XML (extensible modelling language), XHTML (extensible HTML) and CXHTML (compact XHTML). FireServe can optionally build such content dynamically as needed and as instructed by the application. The application can also request that FireServe create such content from scratch or from a base of templates. Templates may be script files, such as WML, that are modified and customised by FireServe in order to create appropriate content and presentation for the user agent or user. Specific templates can be used to service certain groups of devices (e.g., mobile phones, personal digital assistants (PDA's), hand-held computers, pocket computers and smart-phones, amongst others). Alternatively, content can be constructed from the ground up as instructed by the application without the use of templates. There may be no limit on the number of components that make up the FCC, but there are four such optional components: FsDsp, FsGfx, FsStore and FsData. Each component may perform a number of functions.

The FsDsp component specialises in the creation of dynamic server pages. This is the content that is sent to the client device. It enables the application to format the content properly for a particular device. It also deals with memory management and disk access that are part of the content creation. Supplementary functionality may include disk access, static graphics images, error trapping and validation.

The FsGfx component may create dynamic graphics images. These images may be originally created in a FireServe format for speed. When they are ready to be sent to the user agent, they may be converted into an appropriate format for the particular user agent, such as GIF or WBMP. The FsGfx may include functionality for various graphics primitives such as text, pixels, lines, circles, rectangles and sprites (with or without transparency) amongst others. The FsGfx component may also include a landscaping subsystem. The landscaping system allows the creation of virtual worlds on a 2 or 3 dimensional grid system. The scenes are rendered with correct perspective and depth using the FsGfx component's graphics primitives. The FsGfx component can be instantiated by the application or the FAF more than once. Each instance may run in its own thread so that on a computer with more than one central processing unit (CPU) they can execute concurrently for enhanced performance. Some or all instances of the FsGfx component may share the same memory space for their data in order to preserve space. The FsGfx may also include several utility functions to perform post image processing such as image enlargement and reduction.

The FsStore component may be a highly optimised data storage and retrieval component that may be used to store session data for each user that uses the service. The FsStore component may be used by the application to manage data based on the user's username so that the next time a user accesses the service the application may continue from where it left off with the identified user. The FsStore component has been implemented in one preferred embodiment of the present invention as map data structure, using the user name as the key.

The FsData component may be used as a bridge between the application and the FCC. A main functionality of the FsData component may be to simplify data exchange between the application and a data manager.

A FireServe compliant application may be a binary program or a script program that accesses the FireServe components in order to provide a service for a user agent. The user agents supported may include those user agents defined by FireServe but further customisation is also possible by the application itself before sending the content to a third party, the end user or user agent. The application itself may be able to access the operating systems' application programming interface (API) for enhanced functionality as well as APIs of other software such as programs (binary or script), components (binary or script) and libraries (binary or script). The application may optionally be executed as part of a web-server's process or isolated from the web or Internet and as a stand-alone application. Alternatively, the web server can pool several instances of FireServe based applications. A FireServe based application can consist of or comprise several components or libraries.

Optionally, a FireServe compliant application can be built using the FireServe Application Framework (FAF). The FAF is or comprises a hierarchy of software classes that can be used to create FireServe compliant applications quickly. The source-code of the FAF classes is imported into the application's project in order to provide it with FireServe functionality instantly. The FAF classes use object-oriented techniques such as inheritance, encapsulation and polymorphism. The FAF class methods can be overridden and customised by the application in order to modify their functionality. The FAF creates a dynamic link library called the controller, and a binary component that is called the application. Together the controller and the application provide a service. The controller can be configured through the web server, but the application component is an independent stand-alone component that exposes an interface to the controller.

The Controller provides a considerable amount of functionality such as:

Postfield validation from the user agent.

Detects the client's user agent (browser).

Detects the client's preferred language (English, French, German etc).

Instantiates and releases the application object.

Instantiates a FireServe DSP (dynamic server pages) object and passes its interface pointer to the application object.

Can send information to FireServe Supervisor.

Can write debugging information to disk.

Establishes the application's actual folder on the hard disk and passes it to the application.

It creates the necessary HTTP packet headers.

It manages the HTTP sessions.

Performs thread management.

The controller can create one or more threads in order to receive requests from multiple users at a time. It manages the thread pool and schedules the requests before they are processed by the application. For example if the controller decides that 4 threads are needed to process the requests at any one time, it will instruct the application component to also use 4 threads that will connect appropriately to the controller's threads for efficient processing. In turn the application will instruct the FsGfx on how many instances of it will be used to process the 4 requests.

Ultimately the application may have overall control of the service. The application may be empowered to decide if users should be logged in or out, what type of content they will be served, and so on. The controller may guide the application but the application may optionally always have the final say when the application is empowered to override the controller as well as the FCC. The FAF's classes are outlined below.

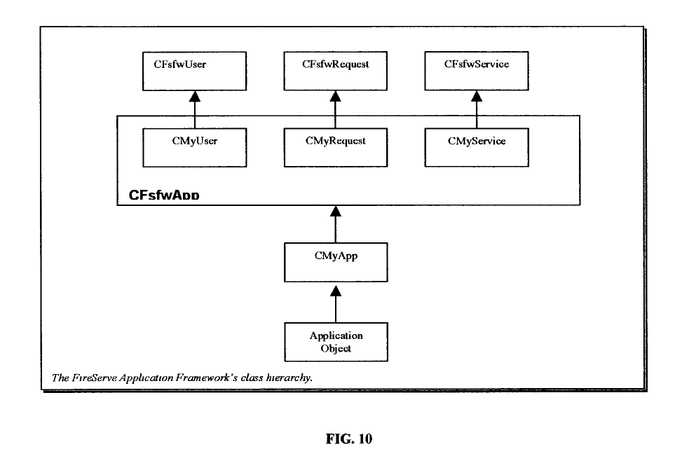

Referring now generally to the Figures and particularly to FIG. 10, the user class is called CFsfwUser and provides storage for a user's data. By default the CFsfwUser may contain data that is essential to track the user's requests. For example, the following information may be stored in the CfsfwUser: the user's name, the service provider name, data designating whether the user is active, the user's device type, the time of the user's last HTTP request, and so on. This class optionally does not contain any member functions. The application specific class may be partly or wholly derived from the CFsfwUser class. The derived class might then be amendable at will. Additionally, a CMyUser class is derived form CFsfwUser and the CmyUser class can be imported into a new project.

The framework's next class is CFsfwRequest, and is used to handle the requests made by a user. The CFsfwRequest incorporates functionality to validate the request and creates an appropriate response responding to whether a request was valid or not. The CfsfwRequest class may run as a thread and by default such threads (i.e., instances of the class) are created. Once again, the CFsfwRequest class is not intended to be used directly. Instead the application should use the CMyRequest class that is derived from an CfsfwRequest class.

A CFsfwService class is a service class. The CfsfwService class is thread based but there is always just one instance of it running. The function of the CFsfwService class is to perform housekeeping tasks. The CFsfwService scans all possible users and keeps track on who is active and who is not. Users that have timed out are marked as inactive and any memory they used may be released. The CFsfwService class also keeps track of the total number of active users at any one time. The application may use a CMyService class that is derived from CFsfwService.

The CFsfwApp class is used to represent the application. It contains the user, request and service classes. By default, the CFsfwApp class contains the CMyUser, CMyRequest and CMyService classes. The CFsfwApp class handles all application-wide activities such as, loading the WML deck templates, memory allocation, thread activation and deactivation etc. The CfsfwApp class may also be responsible for releasing all resources when the application closes down. The application's interface methods can only access directly this framework class and no other. As with the other framework classes, the CfsfwApp class should not be used directly. Instead the CMyApp class should be used which is derived from the CfsfwApp class. The CMyApp class is placed in the inheritance list of the application's class.

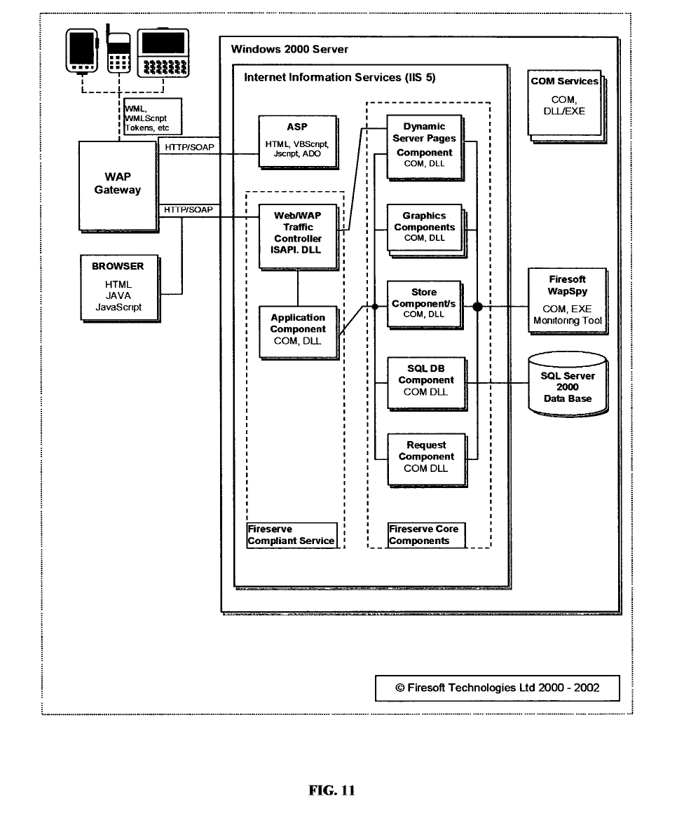

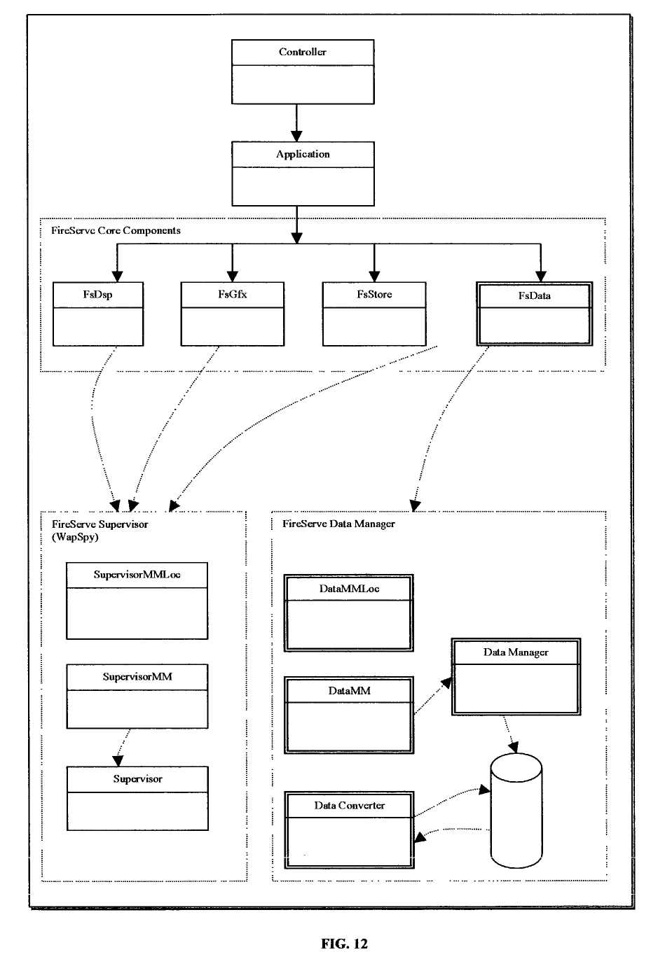

Referring now generally to the Figures and particularly to FIGS. 11 and 12, the FireServe Supervisor may consist of or comprise a number of binary components and an executable program (the application). An early version of the application was called WapSpy. The role of the supervisor of WapSpy was to monitor continuously the state of a FireServe based Web/WAP service. The various components can notify the supervisor of various events of significance. Such events include users logging on and off, user particulars such as the type of the user agent, user name, network provider, service errors and warnings, statistics, number of users on-line per service and many others. Such data may be updated and displayed in real time. This data may optionally be stored on persistent storage media. A FireServe Supervisor can be deployed on the same computer on which the service is running, or on a separate computer on the local area network (LAN) or remotely across the Internet. The supervisor can send and receive notifications to and from, the FireServe Core Components (FCC) or a FireServe compliant application or the FireServe Application Framework (FAF). Its primary function may be to ensure that a service runs satisfactorily. The Supervisor's components may use the remote procedure call protocol (RPC) in order to enable the components to communicate across process boundaries as well as machine boundaries. Communication across the Internet is achieved through RPC tunnelling techniques. Two of the Supervisor's components may optionally always run behind the scenes as stand alone executable programs in order to configure the application's security settings with the operating system. This enables the Supervisor to send data and execute procedures over the LAN and the Internet without the operating system blocking such operations.

A FireServe Data Manager (FDM) may consist of or comprise a number of software components. The FDM's function may include data gathering, data format conversion and storing. The FDM can convert and store a wide range of formats including the FireServe binary formats such as SPR, as well as industry standard formats such as XML. The FDM can be deployed locally on the same machine as the FireServe service, or over the LAN or remotely over the Internet. The cross process communication and remote communication of the components over the Internet is achieved through RPC tunnelling. The FDM is used by FireServe enabled services to record user data. Such data includes the number of hits (visits) to a particular service, the amount of time spent on-line, the days that the service was accessed and so on. This data can then be converted into various formats and be analysed by other applications.

The newly invented Pre-emptive Animation method provides for interactivity when playing animated games on a mobile phone without the need of a scripting language (e.g., WML Script or JavaScript) or logical processing taking place on the client (e.g., a mobile device).

All logic flow of the game application may take place on a remote server. The invented method may mostly bypass the expected latencies and continuous interruptions by pre-processing a variable number of upcoming game turns and feeding them in advance to the phone in one single process. This aspect of the method of the present invention optionally achieves near continuous animation that can be interrupted by the user at any point, thus changing the flow of the game depending on the user input, or by the server when a pre-processed list of game turns runs out. When the user or an event interrupts the process by issuing a command or a request the number of non-processed turns fed to the device may be discarded.

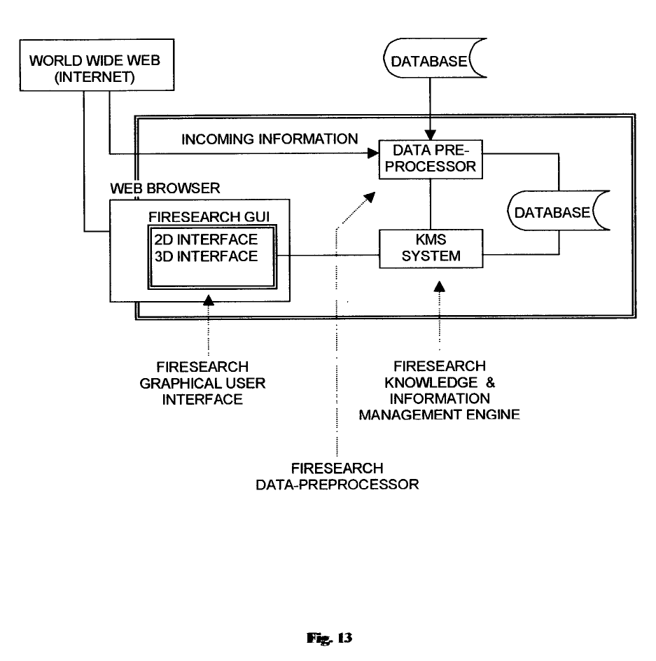

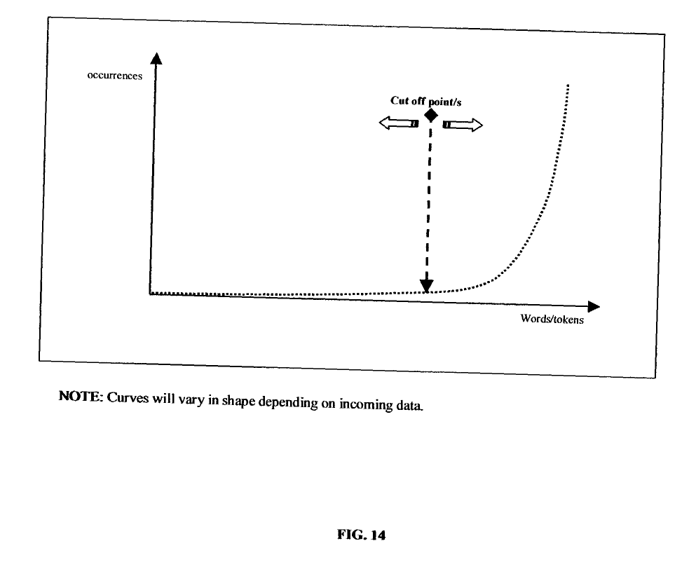

Referring now generally to the Figures and particularly to FIGS. 13 and 14, the FireServe technology makes possible and allows one to achieve this in an efficient manner while serving a large number of players using mobile WAP enabled phones.

FireServe™ also optionally incorporates an innovation that allows for the support of multiplayer, persistent and non-persistent environments (including games) without the use of PUSH WAP technologies, or other suitable technologies or methods known in the art, that normally enable two way communications. Instead FireServe™ may use the timer units found on these devices to enable two-way communication between wireless devices and an arrangement of servers, and/or other wireless devices. The timer on a device may be used to automatically issue a request or requests to a server at intervals to enable for the efficient exchange of data and for synchronizing the events within a multi-user environment so that all participants share the same experience.

FireSearch may be or comprise an advanced search engine and data mining tool that may be built and based upon pattern recognition, and Bayesian statistical methods. Real-time information visualization techniques are employed to present the findings in a novel and constructive manner where information relationships and content are clearly identified and navigation through the information space is greatly enhanced by delivering a robust and efficient knowledge and information management solution.

The invented system 2 accepts information and data generated by FireServe through the m-Card concept as well as through other inputs that include but are not limited to text files, spreadsheets, Internet traffic, streamed data and data from other information sources and media.

FireSearch™ can function on a number of single or networked computers and other devices that include and are not limited to workstations, servers, laptop and portable computers, interactive TV boxes, and mobile and wireless devices, including but not limited to telephones and Personal Digital Assistants (PDAs). Such devices may function independently or as part of a network that include, but are not limited to, landline, optical, infra-red and sonic networks and other methods of data transmission.

FireSearch™ builds an image of the information and knowledge stored on a single or number of networked devices. The image becomes available to a number of users to explore through the proposed interface. Subsequently, knowledge stored on a central server arrangement connected to the Internet becomes automatically available to users with networked devices world-wide, i.e. workstations, interactive TV boxes, mobile phones, laptops, PDA's, etc.

Information may optionally be shared at one, two, several, or any point of the process locally or over a network that includes the Internet, Local Area Networks, Wide Area Networks and other types of networks. The optional employment of an innovative graphical navigation mechanism enables users to individually or collaboratively navigate through clusters of information to view information of their choice. The invented system 2 may be configured to work with any human language, e.g., English, German, Italian, Japanese, and etc.

The interface may be divided into two aspects, i.e. the Human Machine Interface (HMI) and a newly invented 3D Knowledge Navigation Interface.

Input may be achieved by, and is not limited to, two-dimentional devices such as keyboards, light-pens, mice, track balls, joysticks, tablets, and three dimentional input devices such as tracked gloves and wands among others.

Output may be achieved and is not limited to: two dimentional output devices such as Liquid Crystal Displays (LCD) and TFT displays, cathode Ray Tubes (CRT), projectors and three dimentional output devices using optical, shutter glass, polarisation, and laser technologies among others.

The invented system 2 may comprise one or more of the following elements:

a browser based front-end/viewer or graphical interface:

an user input query entry mechanism (described earlier),

a search results text and graphics output system,

a ‘search results' 3D graphical output and navigation mechanism;

an Internet and file based data gathering mechanism;

a text tokenizing mechanism;

a data-mining engine; and

a pre-emptive query indexed database.

The method of the present invention may require a step that imposes the downloading and collecting of data and other information from the Internet and other digital and paper sources including m-Card. Any text and data collected may be tokenized to improve performance prior to any analysis taking place upon the text and data. Tokenized text and data may and often should reflect the structure of the original data to save its original state and context. Irrelevant and inappropriate data may be discarded during this phase before tokenisation takes place. A dictionary might also need to be built at this stage.

A dictionary may or should be created where the occurrences of individual words and other relevant data items are registered. When considering text the trend of increasing words/tokens v. occurrences may be as presented in FIG. 14.

Optionally, only tokens left of the cut-off-point should be used in any statistical analysis, as they will have high identification values. The cut-off-point should be variable and its position may vary from the developers' point of view. All tokens are further processed and a number of derivative values are calculated and stored. All derivative values are indexed to the individual tokens.

If a User Input Query to some extent matched a token or tokens the most relevant data sets with the heaviest weights would be returned as a list of data sets in order of relevance to the query.

Additionally the real-time 3D information browser/viewer may be used to navigate and explore the spatial data returned by FireSearch.

The pre-emptive Query Database may be needed for speeding up the invented system's 2 responses. The Query Processor is responsible for initiating the appropriate weighing mechanism. This depends on the number, structure and type of the search items within the User Input Query. The Query Processor should support logical (i.e. AND, OR, +, NOT) and any other operators that seem appropriate.

Text Output

Following a successful search, any findings may be presented in the browser/viewer window in a traditional manner as seen in popular search engines (e.g., Yahoo, Alta Vista, etc.).

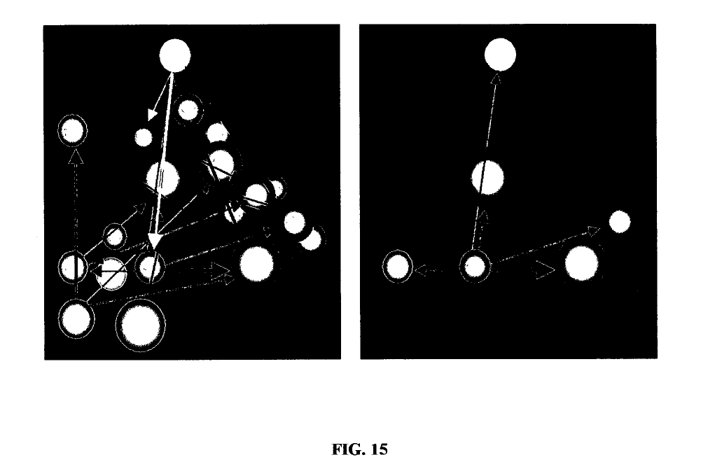

While search results would be displayed according to their context and content weights, their background colour could optionally be changed to reflect simply content. Alternatively they may be colour coded as in FIG. 15.

3D Navigation Mechanism

The optional 3D Navigation Mechanism allows the user to quickly navigate between sets of information. Similar colour spheres mean that the contents are ‘similar’. In other words if the user has read a couple of ‘green’ pages and has not found what he or she wanted he or she may decide to try the ‘red’ pages before examining another group. Content similarity between pages is measured as outlined is the Technical Document 2.

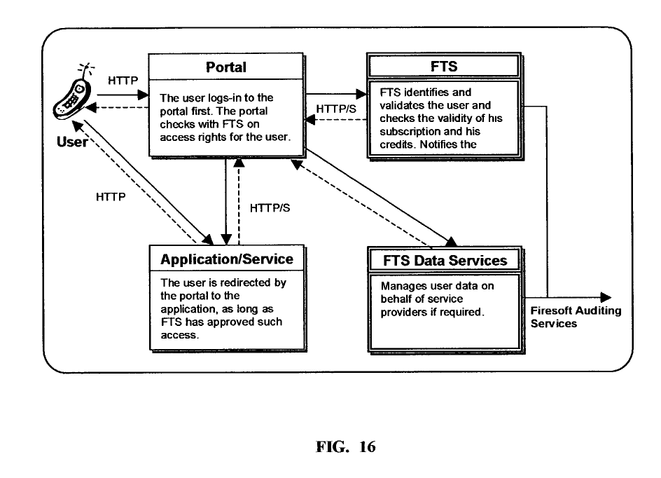

Referring now generally to the Figures and particularly to FIG. 16, the two illustrations of FIG. 16 visualise a simplified real-time 3D view. The user can navigate, pan, rotate and zoom on the model. The user may also choose to isolate a single node in which case only this node and immediate nodes will be shown. This provides for clarity and faster navigation. In a different scenario the user or the invented system 2 may initiate a procedure where the invented system 2 may recommend a path through the 3D structure depending upon the user's account values, current status and previous choices.

It is expected that the text and graphical output might coexist within a page/screen. The ability to browse a selected page/node while manipulating and navigating the 3D model is especially appealing.

The invented system 2 automatically searches through structured and unstructured information or data within a defined domain and isolates members of information relevant to queries. The selected members are subsequently analysed by the invented system 2 and grouped with regard to content. Furthermore, the invented system 2 may dynamically create diverse relationships between the selected members as well as between groups of them.

The interface allows users to access information instantly and intelligently following a request. Requests can optionally also be initiated by the invented system 2. The invented system 2 has the ability to automatically update the image as new information and files are added to the system 2. The invented system 2 is able to assist and guide the user in navigating through the displayed information and knowledge.

Referring now generally to the Figures and particularly to FIG. 8, an innovative real-time and dynamic, three-dimensional interface is used to present and access information associated with the members. Information, knowledge and data are represented in 3D space as 2D and 3D shapes of different color, structure and texture. Members of similar context are depicted in comparable style and are spatially related.

Relationships between groups and/or single members are depicted through links represented in space as 2D and 3D shapes of different colour, structure and texture. Links may be presented and are not limited to; lines of different thickness, colour and texture. These signify the type of relationships. Links and members may have additional information attached to them in terms of supplementary shapes including text. They can also be constructed out of text and other shapes and forms.

Links and members are dynamic in the way they are presented through a session or sessions as some or all of their attributes may dynamically or otherwise change to convey a different set of messages to the user.

The invented system 2 optionally allows for the dynamic manipulation of any of the elements that form the total knowledge structure to facilitate navigation by suggesting worthwhile search paths to a user through a variety of methods. These methods may include and are not limited to:

highlighting useful paths and members;

biding insignificant or non-relevant links, members or groups of members;

marking members visited by the user or newly introduced in the 3D model;

offer different views to different users;

building dynamic paths through the structure depending on users' activities and behaviour; and

introducing new data automatically depending on users' activities and behaviour.

Referring now generally to the Figures and particularly to FIG. 16, a Firesoft Transaction Server (FTS) is a Web-based server application that can enable any portal, to bill its customers for the Web and WAP services that they use. FTS uses open World Wide Web standards for the movement of data over the Internet such as HTTP/SSL (hyper-text transfer protocol and secure sockets layer). It is deployed and managed by Firesoft in order to be used by third parties wishing to take advantage of Firesoft's secure billing system. The secure billing system of the invented system 2 can be integrated remotely with any portal that is deployed on any platform including Windows, UNIX, Linux, .NET and the Java-Runtime-Environment amongst others. In the case of wireless applications, the invented system 2 does not rely on the WAP gateway of the network operators for its functionality.

FTS manages a user's billing details on a subscription and/or credits basis. It keeps track on the user's access rights to a service based on any of the following:

Subscription period.

The level of access (standard or premium services).

The amount of use of particular services based on credits.

The user can initiate, extend or upgrade his or her subscription at any time by logging on to his or her portal of choice, and entering a code into the browser (WAP or web). The code is then passed over to FTS for validation and approval. The portal is then notified by FTS on the level of access that the user is allowed and the appropriate hyper-links to those services are displayed on the browser.

The access code that the user needs in order to use the subscription services can be purchased in a number of ways including:

As part of a retail package;

Over the telephone using a credit card;

Over the telephone using a premium call number; and

Allocated by telecom operators.

FTS can be used by any portal or service that needs billing support. The portal simply communicates with FTS via a published application-programming interface (API) that is available from Firesoft. The customer and the individual applications on the portal do not need to interact or communicate directly with FTS and therefore need not be aware of its presence. The portal is the hub that retains control and enables all parties to participate in its services. FTS can be accessed as soon as Firesoft has allocated a portal (provider) ID and a password to the participating portal. Once a portal has been registered with FTS, the API becomes functional through the use of a URL such as: https://fts.firesoft.com/transact/1/. A third party portal communicates with FTS by using the HTTPS protocol. In order for a portal (or any service) to integrate with FTS, it must have the ability to perform HTTPS requests using the post method. The request's URL can be used to access a particular FTS object. The postfield parameters of the request identify the interface and the method that the portal is making the call to.

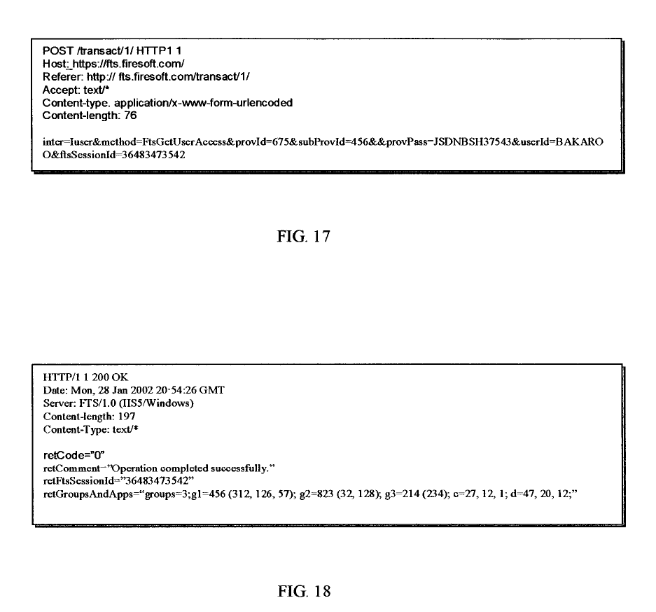

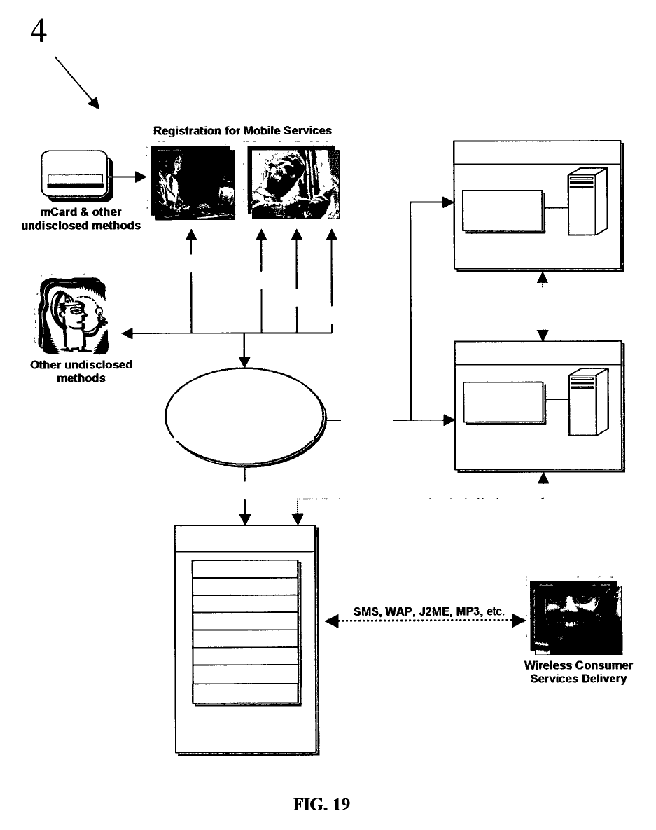

Referring now generally to the Figures and particularly to FIGS. 17 and 18, a typical HTTP/SSL request by the portal to FTS could look something like the pseudo-code of FIG. 17. And a typical HTTP/SSL reply might look something like the pseudo-code of FIG. 18.

Referring now generally to the Figures and particularly to FIGS. 16, 17 and 18, FTS may use digital certificates in order to guarantee that all data exchange between the portal and FTS is secure. A digital certificate may be installed on the FTS server (server side certificate) and the same certificate must also be installed on the portal server (client side certificate) before any HTTPS request/response packets can be exchanged between them. Firesoft issues the digital certificates that FTS will accept. Any requests by the portal to FTS that do not use digital certificates will be rejected. In order to simplify integration of FTS with any third party portals that are based, on the Windows 2000 Server platform, Firesoft can provide on request a COM component that once installed on the portal server, will provide all the necessary functionality for FTS. Full instructions for the deployment and configuration of digital certificates can also be provide.

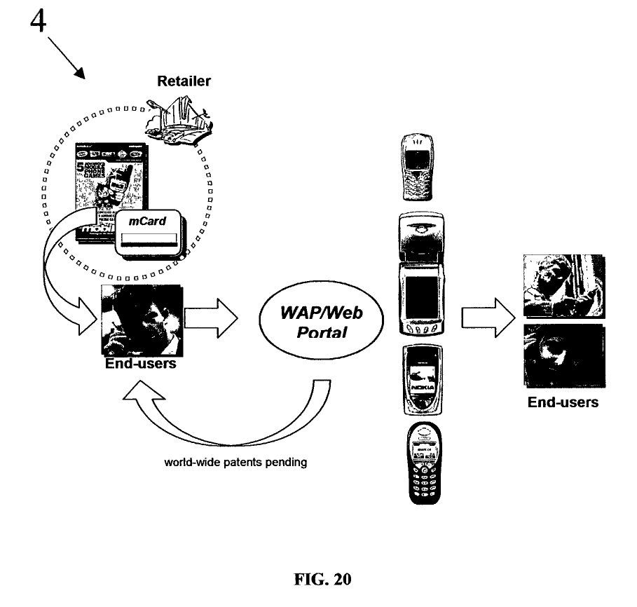

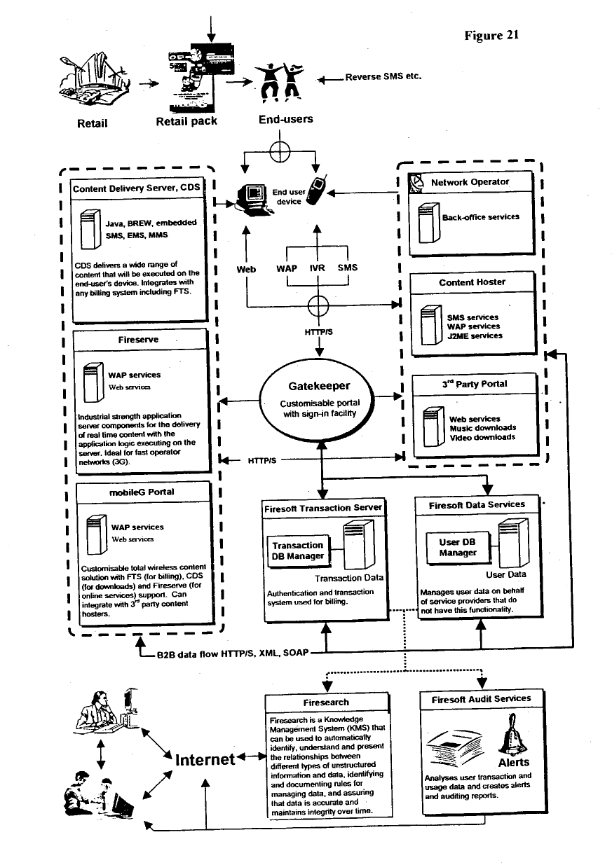

Referring now generally to the Figures and particularly to FIG. 19 and 20, an alternate preferred embodiment of the invented system 4, or alternate system 4, is a full system that depends and makes use of the underlying Firesoft Technologies include Firesoft's own mobileG WAP/Web portal, motGo.com and licensed versions of mobileG that have been adapted for 3^{rd} parties, i.e. MViva-Holland, Orange-UK, TMotion-Germany, Tmotion-UK and Tmotion-Austria. The invented system 2 may optionally comprise a number of components, to include

the mCard billing retail mechanism and other mechanisms (FIG. 2.);

disclosed and end-user registration mechanisms/interfaces (i.e. SMS, IVR, etc.);

the Firesoft Transaction and authentication Server—FTS;

the Gatekeeper; manages the secure exchange of data between inputs, portals and FTS;

Firesoft Data Services; capture and store mobile traffic data for billing, reporting, visualising and market analysis purposes—FDS; and

mobileG; a customizable total wireless gaming solution.

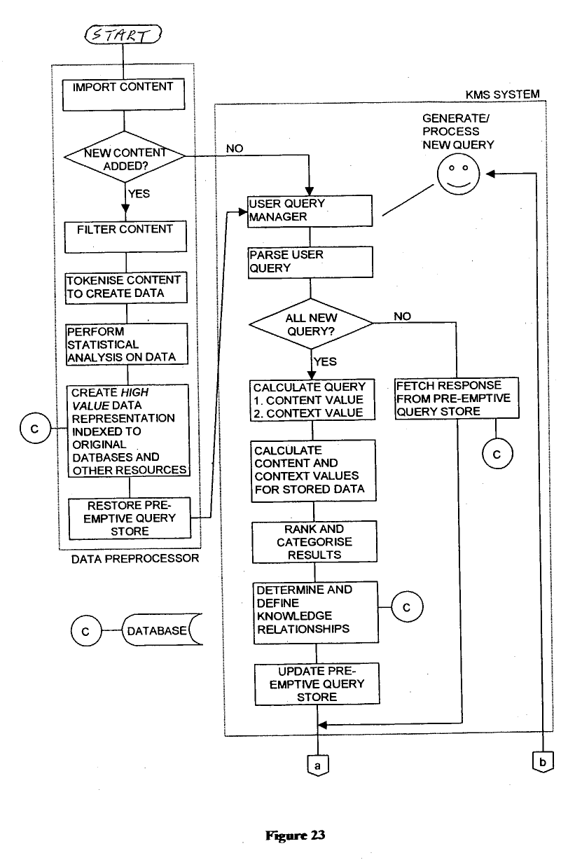

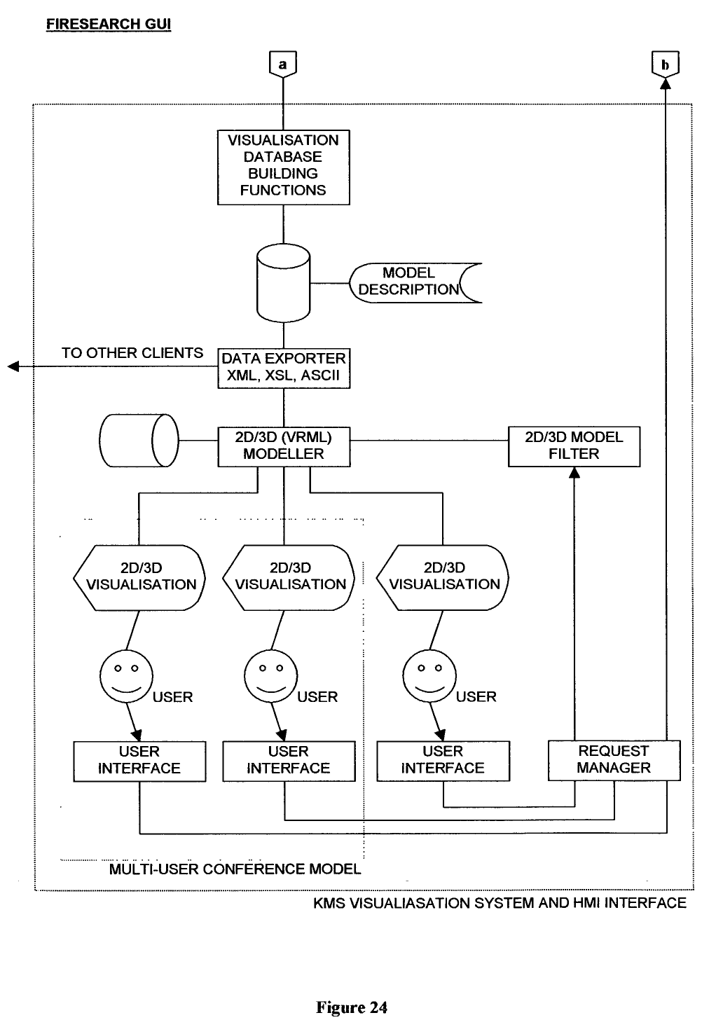

Referring now generally to the Figures, and particularly to FIGS. 19, 20, 21, 22, and 23, the alternate system 4 enables the development, delivery, management, auditing and billing of wireless applications and services dependent or independent of telecommunications operators world-wide and via retail as required. Alternate system 4 comprises novel and non-obvious elements of the present invention that have been successfully deployed on mobileG, and with Ericsson, TMotion (Deutsch Telecom), Orange, MViva and other parties. Alternate system 4 provides a range of component based technologies that can be used by 3^{rd} parties to build and deploy systems that empower new and exciting business models. Such systems may also be developed and deployed by ventures on behalf of our clients and partners.

Alternate system 4 may comprise elements in accordance with the method of the present invention, to include:

FTS—Firesoft Transaction Server (micro-billing system for wireless services)

Authentication & Billing Services

Auditing Services

Data Services

mCard support

mCard—end-user retail billing system enabler

FTS support

CDS—Content Delivery Server for mobile devices

J2ME, BREW, C/C++

SMS, EMS, MMS

Gatekeeper—log-in/registration service for mobile services

The Firesoft Total Mobile Portal Solution for 3^{rd} parties

FTS and CDS support

mCard support

Gatekeeper support

FS Authorware support

FS Authorware—content management solution for WAP/Web portals

Fireserve—Wireless Application Server (WAP delivery server)

Firesoft Mobile Content—content for mobile devices

FTS offers end-user authentication and billing capability to a content provider across the Web and the mobile Internet. FTS works on a network over a client device from anywhere in the world. In certain preferred embodiments, FTS can track end-users across partner sites on a single account e.g. UK, French and US services.

FTS may be or comprise a Web-based server application that can enable a portal, to bill its customers for the Web and WAP services that the portal offers. FTS may use open World Wide Web standards for the movement of data over the Internet such as HTTP/SSL (hyper-text transfer protocol and secure sockets layer). FTS may be deployed and managed within the method of the present invention in order to be used by a third-party that wishes to take advantage of a secure billing system. FTS can optionally be integrated remotely with certain portal deployed on platforms including: Windows, UNIX, Linux, .NET and the Java-Runtime-Environment amongst others. In the case of wireless applications, the system does not rely on the WAP gateway of the network telecommunications operators for its functionality.

Firesoft Transaction Server (FTS):

is designed for on-line & retail transactions in conjunction with mCards

integrates to a portal using provided APIs

uses standard interfaces, i.e. HTTP/S,

provides XML, SOAP support

extremely secure using mCode encrypted number system

multi-optional access levels

supports all on-line media content (SMS, WAP, J2ME, MMS, streaming, etc.)

GSM, GPRS, 3G support

secure on-line administration management

FTS manages a user's billing details on a subscription and/or credits basis. FTS may optionally keep track of the user's access rights to a service based on one or more of the following:

credits

subscription period

per second

per packet (of variable value, where applicable)

number of bytes sent/received

the level of access (standard or premium services)

The user can, in certain preferred embodiments of the present invention. initiate, extend or upgrade his or her subscription by logging onto his or her portal of choice, and entering an mCode into the browser (WAP or web). The mCode is then passed over to FTS for validation and approval. The portal may then notified by FTS on the level of access that the user may be allowed and the appropriate hyper-links to those services are displayed on the browser.

The mCode comprises an access code that the end-user needs in order to gain access to a service can, in various alternate preferred embodiments of the present invention, be purchased in a number of optional ways including:

As part of a retail package;

Over the telephone using a credit card;

Over the telephone using a premium call number;

Allocated by telecom telecommunications operators; and

Reverse SMS.

The Transaction Server acts an auditor between content publishers and content providers. As there is a tendency for content publishers to pay content providers only when their content is used, it is often important and/or valuable that an independent party audits these figures. FTS has the capability to produce accurate figures in real-time and present these as sets or reports accessible via a Web-browser over a secure connection.

Real-time access to statistics may be offered through a Web browser like Internet Explorer. A WAPSpy component may be deployed by alternate system 4 that automatically intercepts and collects valuable mobile data. This captured data may optionally be saved inside an SQL database for later use.

FRS (Firesoft Report Services) automatically accesses the stored mobile data and automatically creates reports that can be viewed through a standard browser over the Internet. These reports may be updated in real-time. This optional real-time data monitoring may occur while end-users are connected via a mobile phone to an operator's network world-wide. The system works independent of telecommunications operators and can be localised or fine tuned to satisfy requirements. Auditing can take pace on a number of carrier technologies including WAP access, SMS, EMS; MMS, J2M2, BREW, and C/C++ binary downloads.

Optionally, FTS Data Services can be used to store end-user data. This service may be intended for service/content providers who do not wish to deploy their own user database.

The FTS authentication and billing databases as well as the FTS Data Services user database are used to create the auditing and other reports as required.

The mCard concept may be used in certain alternate preferred embodiments of the present invention to bypass the traditional billing mechanisms designed and adopted by telecommunications companies. mCards enable managers of invented system 4 to bill consumers directly (nationally and internationally) for the provision of services over wireless networks, including GSM, GPRS and 3G.

The alternate system 4 enables third party managers to provide and charge for their services, without the need of telecommunications operators. It encourages and enables the formation of new open markets, offering the consumer a superior alternative.

The method of the present invention optionally allows the end-user to purchase a time-period based, e.g., or a monthly, bimonthly or yearly, subscription of data services ‘over the counter’. This is the familiar purchasing experience that consumers are very comfortable with and allays fears associated with on-line transactions. The subscriber can renew their subscription either by purchasing another product from the retail store, or by subscribing to the service online.

Certain alternate preferred embodiments of alternate system 4 have many advantages over existing billing methods in that:

it is a very simple transaction in a form that the subscriber is completely comfortable

anyone can purchase this product, either on the subscriber's behalf or as a present for the subscriber

the subscriber is not worried about the ‘hassles’ of turning off and turning on a standing order style subscription

the subscriber is free to choose the best services

with GPRS and 3G, the ‘always connected’ mindset will fund the drive towards this kind of service

The manager of alternate system 4 or a third party manager of alternate system 4 can optionally program an mCard on behalf of a partner, limiting access to certain applications and services only. Access rights may dynamically change even after the mCards have been distributed to the retailer. For example, suppose that a partner wished to publish two games (i.e. Game A, Game B) on mobileG. The publisher may thereupon release two mCard types. One may give access to Game A and the other may give access to Game B. Later in the products' life the publisher may decide that either mCard can access both games, and also offer a preview of a new game. This could be easily implemented without the need for new mCards.

Market forces are likely to sometimes dictate when these cards will become available. In this model partners will have the option to submit their products for inclusion in mobileG if they wish. Applicant will manufacture and distribute the cards, which will be marketed under the mobileG label.

The Content Delivery Server (CDS) can deliver a wide range of content to an end-user device. CDS can, in certain preferred embodiments of the present invention, integrate with a billing system (including FTS) across the Web and the mobile Internet. CDS can optionally be deployed independently if required and does not rely on other aspects of the method of the present invention.

The Content Delivery Server (CDS) may be or comprise a Web-based server application that can be used to provide content downloading services. The downloads can include data such as graphic images and applications (J2ME or binary data for embeded applications) amongst others.

CDS may be designed to be integrated to a portal that adheres to the CDS specification. CDS provides interfaces to the Firesoft Transaction Server (FTS) for its billing operations and can equally interface with other billing platforms. All data exchanges take place using the HTTP and HTTPS protocols.

Communication with portals and FTS can be performed under HTTPS for enhanced security. Since CDS may use standard World Wide Web protocols in order to communicate with portals and FTS, CDS may be platform independent and therefore it can be used by portals that run under a suitable operating system and/or Web server known in the art.

Content Delivery Server formats optionally supported may include the following:

J2ME, BREW, C/C++ binary downloads

SMS, EMS, MMS

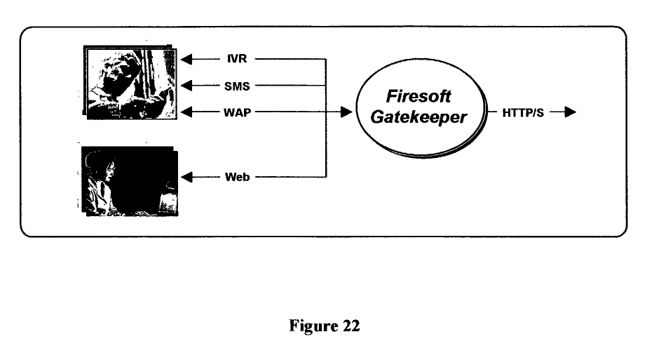

Referring now generally to the Figures and particularly to FIG. 21, the Gatekeeper may be or comprise a login and registration service that can be used by certain portals that do not support such functionality. Gatekeeper may be or comprise a hub that keeps track of end-user navigation over a plethora of content hosts and portals. The Gatekeeper may be highly customisable and optionally offer transparent support for FTS authentication. End-users can register/login via Web, WAP, SMS and interactive voice response (IVR).

The method of the present invention provides a set of modular technologies that allow for the design and deployment of flexible, 3^{rd} party-defined wireless business models. Such business models may be designed in accordance with the method of the present invention. The ability to interface some or all implemented aspects of the method of the present invention to existing or 3^{rd} party incomplete systems using standard interfaces may also available.

Authorware may be or comprise a menu driven Windows application that allows content managers to create dynamic Web and WAP pages with minimal technical knowledge. The content author simply needs to specify the general structure of the site in the form of a ‘tree’, insert the required text in simple text windows and specify the graphics before the system automatically creates a graphically rich XML version of the pages.

In turn the system automatically creates the relevant WAP(WML) and Web(html) pages depending on the browser where the content is viewed by the end user.

FireServe™ may be or comprise a highly optimised, multithreaded C++ based software server solution that supports load balancing. FireServe™ may be geared to deliver content to wireless devices and can support real-time single and multi-user environments.

FireServe™ allows for complex and demanding applications that include games and multimedia content. High efficiency in the server may be preferred due to a combination of small inefficient caches, and the inability of most WAP mobile devices to handle WML and WML Script satisfactorily. FireServe™ has been designed and developed to take advantage of GSM, GPRS and 3G technologies and conforms to standards. Support for Java phones is provided in certain alternate preferred embodiments of the present invention.

FireServe™ server allows complex games and other applications to be processed on a Windows 2000 server arrangement rather than on the mobile device. This arrangement allows all WAP mobile phones that are capable of displaying graphics to run games far more complex than are currently available.

FireServe™ currently supports all WAP phones that include devices from Motorola, Ericsson, Nokia, Sony, Mitsubishi, Siemens, etc. Real-time animation is supported on only some of these phones to varying degrees. Once installed FireServe™ can be in control of games applications running on the server and can process user requests accordingly.

FireServe™ has been developed in C++ using MS COM/DCOM (Active X) technologies and runs under Windows 2000 Server or later. The run-time server architecture may be highly modular and allows for remote monitoring and control over an Internet browser or mobile phone.

In an optimal situation and in an effort to maximise resources FireServe™ could reside on the WAP Gateway server. This would further enhance performance and reduce costs. For this to be able to happen the cooperation of the telecommunication operator may be necessary. FireServe™ may be or comprise not just a WAP server, it can be used to distribute content over a variety of carrier technologies, efficiently outperforming similar JAVA solutions by a factor of 5-10:1. For graphics based applications the 5-10:1 performance ratio is likely to increase further where in some cases JAVA solutions would fail to deliver altogether.

FireServe™ produces unparalleled performance by having direct access to the operating system including software and hardware multimedia and graphics subsystems. FireServe™ has been designed to deliver text, graphics, sound, animations, video etc. FireServe™ may be or comprise a highly optimised multithreaded server application taking full advantage of multi-processor systems and has been designed with load balancing in mind.

The FireServe™ architecture can provide efficient, real-time delivery of content over GSM, GPRS and 3G. Content can include text, graphics, animations, sound and video where supported by mobile devices.

FireServe™ comprises a collection of binary components implemented using the COM (component object model) specification running on the Windows 2000 operating system. The major advantages of COM as found in FireServe™ are:

Object-orientated design—COM objects support encapsulation, inheritance and polymorphism, the three cornerstones of object-oriented design.

Programming language independence—COM objects can be programmed in suitable languages known in the art that can support the binary layout that COM specifies.

Reusability—Because COM objects are encapsulated and their implementation is isolated from the interface, they are reusable.

Interoperability—COM objects promote interoperability among applications and objects. More than one application or component can share the same COM object.

Location transparency—COM objects are location independent. They can be placed on the same computer or on different computers.

Independent, uncoordinated evolution—Because COM is extensible, COM objects can evolve without breaking their predecessors.

Deployment—COM objects are self-contained, reusable components, making them relatively easy to deploy and use.

Efficiency—COM objects are efficient in that they can be small, light, fast, and easy to deploy, can evolve and can be deployed anywhere.

The FireServe™ components have also got the following characteristics:

Coded in highly optimised C++ and assembly for top performance.

Small footprint so that they can be deployed even on moderate servers.

Multi-threaded components incorporating thread pooling for maximum design flexibility.

Bi-directional component communication.

Seamless integration with IIS (Internet Information Services).

Full access to the services of the operating system i.e. Direct X, MS Media Services.

Expandable across the LAN for distributed processing.

Ideal for rapid application (service) and content development due to the DSP (dynamic server pages) sub-system.

Easy performance monitoring, locally or remotely via the W@PSPY™ component.

The run-time server architecture is highly modular and allows for remote monitoring and control.

FireServe™ incorporates W@PSPY™ that allows for the remote real-time on-line monitoring of FireServe™ and of the applications running on it. FireServe™ also has support for on-line debugging and performs accurate data collection. This data may be used for billing purposes, statistical analysis and network monitoring. Mobile users can be monitored individually and in real-time while connected to the server, their every action being visible to the server administrator.

Billing can be done per second (depending on network latency), per request, per packet received, or for the amount of data received by the user to the closest byte. The range of information that can be gathered may include information that a company may need to know about activity on their network. This information may include:

phone type and model.

user name or identity.

applications or parts of applications accessed.

time and date of access.

debugging support

error checking

automated virus/hacker checking.

WAPSpy may be run as a background application and because of its minimal use of resources does not interfere with the normal running of the computer or network.

Data collected by WAPSpy can be utilised in a number of ways:

tracking of users by time, date, location etc.

performance or reliability of specific handset and server arrangements.

traffic flow from specific locations.

market research data.

data collation for strategic planning.

security performance over time.

automatic generation of reports on-line—for business, marketing, etc.

To best create a Fireserve based application the developer may need to be familiar with a number of topics.

Using Windows 2000 and Internet Information Services.

Using a WAP simulator that runs under Windows 2000.

Knowledge of the wireless mark-up language (WML).

Familiarity with the HTTP stateless protocol.

A working knowledge of the Visual C++ IDE and C++.

Basic understanding of the component object model (COM).

In order to create a Fireserve based service two projects can be built. The first is the ISAPI (Internet Server API) Controller that is used to manage the HTTP traffic between IIS and the application. The controller may be implemented as a standard ISAPI DLL. The second project is the application, which is a COM based component. Both of these projects can be built using Visual C++ 6.0 with service pack 3 or later installed. To simplify the development of the application COM component, the Active Template Library (ATL) may be used. This enables a new component to comply with the COM specification and be able to be used by other programs and components. Once a basic ATL based COM object has been created, the Fireserve Application Framework (FAF) can be deployed to create a running application quickly. The FAF may be or comprise a collection of C++ classes that encapsulate the necessary functionality to build a Fireserve compliant application. The framework can be customised to various degrees in order for the application to provide the desired functionality.

Those skilled in the art will appreciate that various adaptations and modifications of the just-described preferred embodiments can be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practised other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

What is claimed is:

1. A method of enabling access to an applications program via a wireless telecommunication service, wherein the applications program is associated with a digital computer, the method comprising:
establishing a communications link via the wireless telecommunications service to the digital computer;
transmitting account identification information via the wireless telecommunications service to the digital computer;
requesting access to the applications program services via the wireless telecommunications service;
transmitting the account information to a credit authorizing module; determining if the account identification information is associated with a credit value, and if the associated credit value is sufficient to authorize access to the applications program; and
permitting access to the applications program via the wireless telecommunications service when a response from the credit authorizing module is positive, and wherein when the response is negative service is denied.

2. A method according to claim 1 wherein the account information references data from any one of credit card number, debit card number, authorisation PIN code, and prepayment amount.

3. A method according to claim 1 wherein the requesting of access occurs over a digital control channel.

4. A method according to claim 1 wherein the method proceeds in accordance with registration procedures defined in the Digital Advanced Mobile Phone System (D-AMPS) standard.

5. A method according to claim 1 wherein the method proceeds in accordance with registration procedures defined in the Advanced Mobile Phone System (AMPS) standard.

6. A method according to claim 1 wherein the method proceeds in accordance with registration procedures defined in the Code Division Multiple Access (CDMA) standard.

7. A method according to claim 1 wherein the method proceeds in accordance with registration procedures defined in the Global System for Mobile Communication (GSM) standard.

8. A method according to claim 1 wherein the method proceeds in accordance with registration procedures defined in the Personal Digital Cellular (PDC) standard.

9. A method according to claim 1 wherein the prepayment method works collectively in accordance with any one of Advanced Mobile Phone System (AMPS), Total Access Communication System (TACS), and Nordic Mobile Telecommunication System (NMT).

10. The method of claim 1, further comprising providing a user interface to a mobile terminal that permits a user to select prepaid access for home service area accesses, visiting service area accesses, or both.

11. The method of claim 10, wherein the method further comprises transmitting the credit information when requesting access to a service area type selected by the user for prepaid access.

12. The method of claim 1, wherein the communications link is formed between the digital computer and a cellular telephone.

13. The method of claim 1, wherein the communications link is formed between the digital computer and a wireless communicator.

14. The method of claim 1, wherein the applications program comprises a computer game.

15. The method of claim 1, wherein the applications program comprises an animation generator.

16. The method of claim 1, wherein the applications program comprises a database management system.

17. The method of claim 1, wherein the applications program comprises an avatar.

18. The method of claim 1, wherein the applications program comprises a software agent.

19. The method of claim 1, wherein the wireless telecommunications service acts in accordance with the DoCoMo standard.

20. A prepayment system for accessing application programs via a wireless telecommunication network comprising:
a data storage medium having preprogrammed subscriber credit information wherein a mobile terminal transmits the subscriber credit information stored in the data storage medium via the wireless telecommunications; and
a prepayment clearing house for verifying the transmitted subscriber credit information requested via the wireless telecommunication network, wherein prepayment access to the applications program is permitted to the mobile terminal following a positive response from the clearing house regarding the subscriber credit information, and wherein access denied to the mobile terminal following a negative response.

21. The prepayment system of claim 20, wherein the data storage medium comprises a substantially flat card.

22. A prepayment system according to claim 20 wherein the credit information is obtained front the mobile terminal by wireless means in response to a control signal message.

23. A prepayment system according to claim 20 wherein the prepayment clearing house is a credit card verifying entity.

24. A prepayment system according to claim 20 wherein the mobile terminal is a roaming terminal requesting access to a visiting wireless telecommunication network.

25. A prepayment system according to claim 20 wherein the mobile terminal accesses an applications program from a home service provider of the mobile terminal provider via the automated prepayment system.

26. A prepayment system according to claim 20 wherein the mobile terminal is operating within the home service area of the mobile terminal and requests access to a competing wireless telecommunication network covering substantially the same area as the home area.

27. The system of claim 20, further comprising a user interface, associated with the mobile terminal, for selecting the at least one service area type.

28. The system of claim 27, wherein the at least are service area type includes at least one of a home service area and a visiting service area.

29. The system of claim 20, wherein the data storage media further comprises subscriber profile information.

30. The system of claim 20, wherein the data storage media further comprises access level authorization information.

31. A mobile terminal for automatically transmitting subscriber credit information in order to obtain access to an applications program, wherein the application program is associated with a digital computer, the terminal comprising:
memory for storing the subscriber credit information;
transmission means for transmitting a registration message via the telecommunication network to the digital computer and for selectively transmitting the subscriber credit information to the digital computer when the mobile terminal is located in a visiting service area; and
display means for displaying information on the mobile terminal.

32. A mobile terminal according to claim 31 wherein the credit information is entered into the memory via a data input module of the mobile terminal.

33. A mobile terminal according to claim 31 wherein the credit information is entered into the memory by wireless transmission means.

34. A mobile terminal according to claim 31 wherein the display means is capable of displaying an alpha numeric response message to an access request.

35. A mobile terminal according to claim 31 wherein the mobile terminal is capable of multi-band operation.

36. A mobile terminal according to claim 31 wherein the mobile terminal is capable of multi-standard operation thereby permitting access to a plurality of wireless telecommunication networks operating in accordance with different standards.

37. The mobile terminal of claim 31, further comprising a user interface means for permitting a user of the mobile terminal to select at least one service area type for which the subscriber credit information may be transmitted.

38. The mobile terminal of claim 37, wherein the at least one service area type includes one of a home service area and a visiting service area.

39. The mobile terminal of claim 31, wherein the mobile terminal is a cellular telephone.

40. The mobile terminal of claim 31, wherein the mobile telephone is a wireless communicator.

41. A method for prepaid access to an applications program via a radio communication system, wherein the applications program is associated with a digital computer, comprising:
programming a data storage medium with subscriber credit information;
transmitting a registration message from a mobile terminal via the radio communication system to the digital computer;
transmitting via the radio communication system to the mobile terminal, a request for the programmed subscriber credit information;
transmitting, from the mobile terminal to the radio communication system, the programmed subscriber credit information; and
selectively permitting the mobile terminal to access the applications program via the radio communication system based on an evaluation of the subscriber credit information.

42. The method of claim 41, wherein the subscriber credit information includes a prepayment amount.
